(19) United States
(12) Patent Application Publication
(10) Pub. No.: US 2007/0292566 A1
(43) Pub. Date: Dec. 20, 2007

(54) Edible spoon for administering liquid medications

(76) Inventor: Sergio K. DeGennaro, Westbury, NY (US)

Correspondence Address: GOTTLIEB RACKMAN & REISMAN PC, 270 MADISON AVENUE, 8TH FLOOR, NEW YORK, NY, 10016-0601, US

(21) Appl. No.: 11/548,776

(22) Filed: Oct. 12, 2006

Related U.S. Application Data
(60) Provisional application No. 60/805,024, filed on Jun. 16, 2006.

(51) Int. Cl. A23G 3/50

(52) U.S. Cl. 426/104

(57) ABSTRACT

A lollipop with a conventional stem or handle and an edible part in the shape of a spoon for administering liquid medications is provided. The lollipop is used to administer liquid medications to children, developmentally challenged adults, or adults who dislike the taste of liquid medications. The lollipop spoons can be packaged for sale individually, as a package, or together with containers of liquid medications.

### RELATED APPLICATIONS

This application claims priority to U.S. provisional application Ser. No. 60/805,024 filed Jun. 16, 2006 and incorporated herein by reference.

### BACKGROUND OF THE INVENTION

A. Field of the Invention

This invention relates to a device for administering liquid medications.

B. Description of the Prior Art

The existing methods of administering liquid medications involve conventional spoons or measuring cups. The disadvantage of these implements used for administering medications to children is that these implements provide no incentive to take medication to children who dislike the taste of liquid medications or who simply do not wish to take medications. Furthermore, due to the viscous nature of some liquid medications, some of the medication remains on the conventional spoon or the walls of the measuring cup after the majority of the liquid medication is administered, wasting the medication and, thus, not providing the child with an adequate doze.

What is needed is a utensil for administering liquid medications that will give children and adults an incentive to take liquid medications that do not taste well, as well as an incentive to leave none of the medication on the conventional spoon or in the measuring cup.

### SUMMARY OF THE INVENTION

The present invention meets the need for a superior utensil for administering liquid medications. The invention is an edible spoon for administering liquid medications, or a lollipop in the shape of a spoon for administering liquid medications. The lollipop has a conventional stem handle, and the edible part of the lollipop is formed in a shape of a spoon. The lollipop can be used to administer liquid medications to children, developmentally challenged adults, or it can be used for taking liquid medications by adults who dislike the taste of these medications. This creates an incentive for children and adults to take liquid medications and to leave no medicine on the lollipop, as often happens with conventional spoons and measuring cups.

The lollipop may also have a retaining bulb on the end of the stem that is encased into the spoon-shaped edible part—the bulb stops the edible part from becoming loose and sliding off the stem (handle), even when wet, until the edible part is dissolved. The bulb may be of various shapes safe for children. The conventional stem of the spoon-shaped lollipop may be replaced with a large, wide and stable handle to facilitate the pouring and administration of medications by keeping the spoon-shaped edible part horizontal when necessary. The large, wide handle may also have a retaining bulb.

### BRIEF DESCRIPTION OF THE DRAWINGS

FIG. 1 shows a side view of a lollipop constructed in accordance with this invention;

FIG. 2 shows a top view of the lollipop of FIG. 1;

FIG. 3 shows a perspective view of the lollipop of FIG. 1;

FIG. 4 shows a side view of a cylindrical package containing several lollipops constructed in accordance with this invention;

FIG. 5 shows a side perspective view of a cylindrical package containing a bottle and several lollipops constructed in accordance with this invention;

FIG. 6 shows a side view of a cylindrical package containing several lollipops constructed in accordance with this invention;

FIG. 7 shows a perspective view of the package of FIG. 6;

FIG. 8 shows a top view of a package with an alternate embodiment of the lollipops;

FIG. 9 shows a perspective view of a bottle with several lollipops attached thereto;

FIG. 10 shows a perspective view of a cylindrical package with a bottle contained on the inside and several lollipops attached to an outer wall of the package; and

FIG. 11 shows a perspective view of a rectangular package with several lollipops constructed in accordance with this invention.

### DETAILED DESCRIPTION OF THE INVENTION

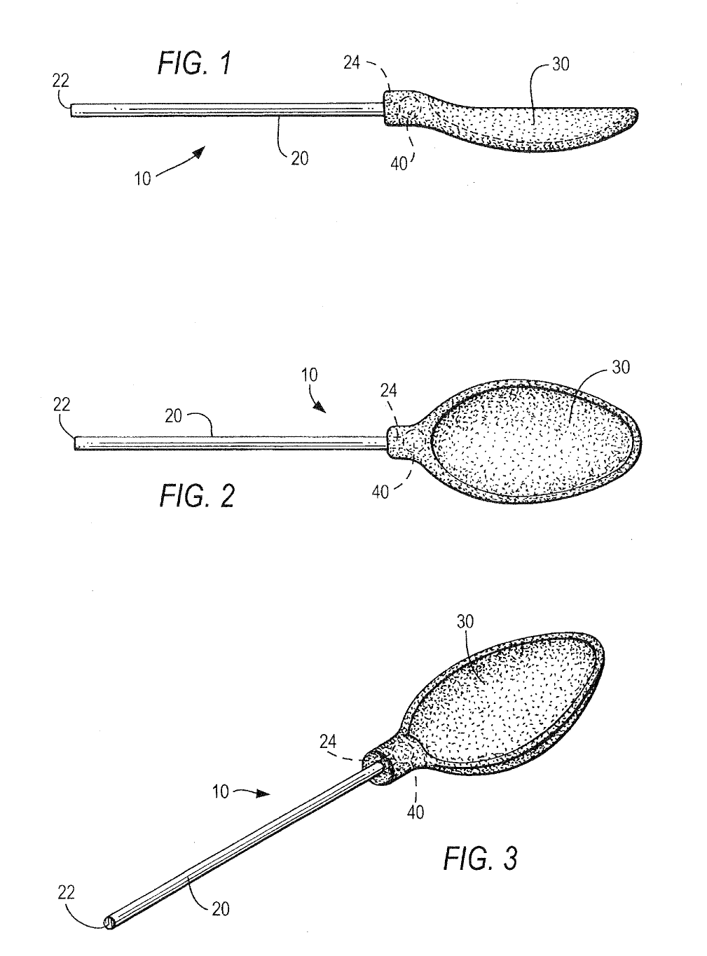

With reference to FIG. 1-3, a lollipop 10 has a stem 20 and an edible part 30, which can be made from any confectionary materials suitable for lollipops. The edible part 30 is manufactured in the shape of a conventional spoon, preferably the size of a teaspoon, but it can also be manufactured in the size of a dessert spoon, table spoon, or any other size convenient for measuring and administering liquid medications. The stem 20 has a first end 22 and a second end 24. The first end 22 is where the user generally grips the edible spoon of the present invention to administer the liquid medication, and for later consumption of the edible part 30 of the lollipop 10. The second end 24 is encased in the edible part 30 so as to longitudinally align the stem 20 and the edible part 30 and enable the user to administer liquid medication as with a conventional spoon.

The stem 20 may further have a retaining shape or structure 40 on the second end 24 that is encased in the edible part 30, the retaining shape or structure 40 also being encased in the edible part 30 together with the second end 24. The retaining shape or structure is preferably spherical, as illustrated in FIG. 1-3, or bulb-shaped, but it can be any safe-for-children shape the largest cross-section of which is greater than the diameter of the stem 20.

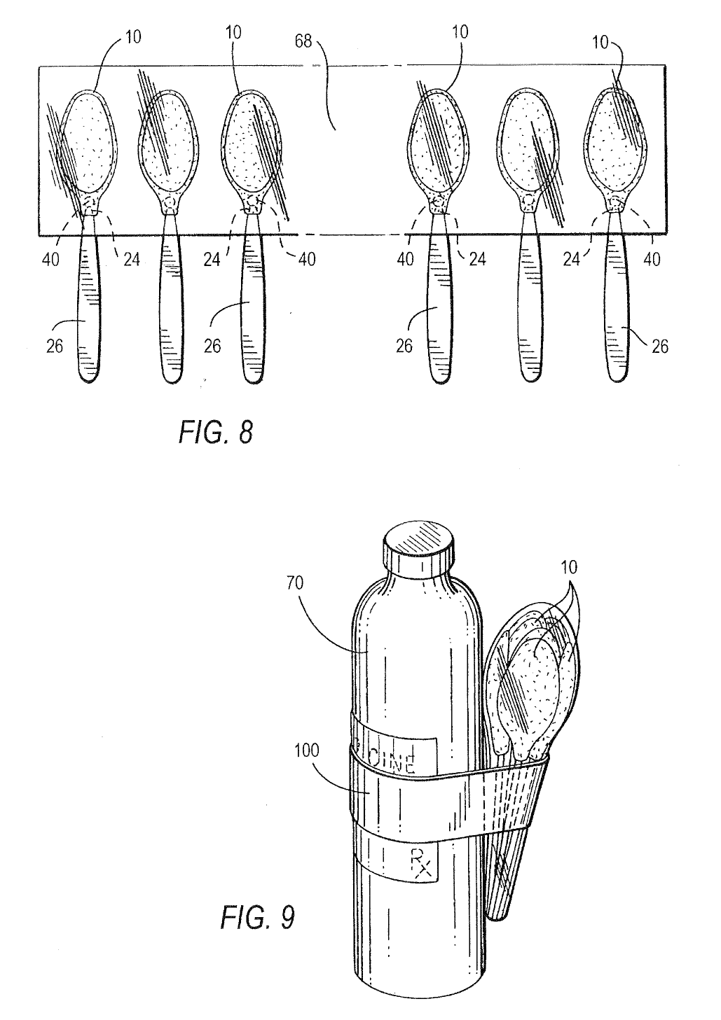

FIG. 8 illustrates yet another embodiment of the edible spoon where the stem 20 (not shown) of the lollipop 10 is replaced with a handle 26, which may be a flat handle such as that commonly used in spoons. The flat handle 26 facilitates easier handling and balancing of the lollipop 10 when the liquid medication is administered. The handle 26 may also have a retaining shape or structure 40 on the second end 24 as described herein.

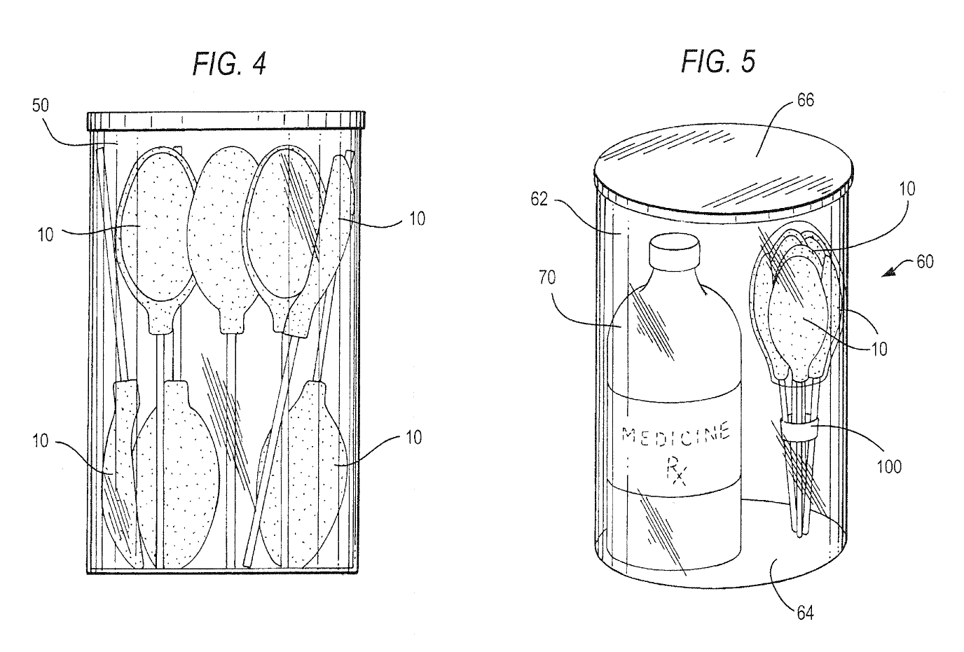

The edible spoon can be sold individually or, as FIG. 4 illustrates, in packages of multiple units where multiple lollipops 10 are sold in a container 50, but the edible spoon for administering liquid medication can also be distributed with various bottles of medication as illustrated in FIG. 5-7 and FIG. 9-11.

With reference to FIG. 5, a number of lollipops 10 can be packaged in a container 60 that has a wall 62, a bottom 64, and a detachable lid 66 that fits on the body, closing the container. A bottle of medication 70 is also disposed in the container, together with the lollipops 10 that are preferably individually wrapped and held together by a rubber band 100 or a similar restraint. The bottle of medication 70 and the lollipops 10 may further be secured to the inside of the wall 62 (interior of the container 60) to eliminate internal wobbling. FIG. 8 also illustrates a number of edible spoons (lollipops 10) packaged in a row within a strip 68.

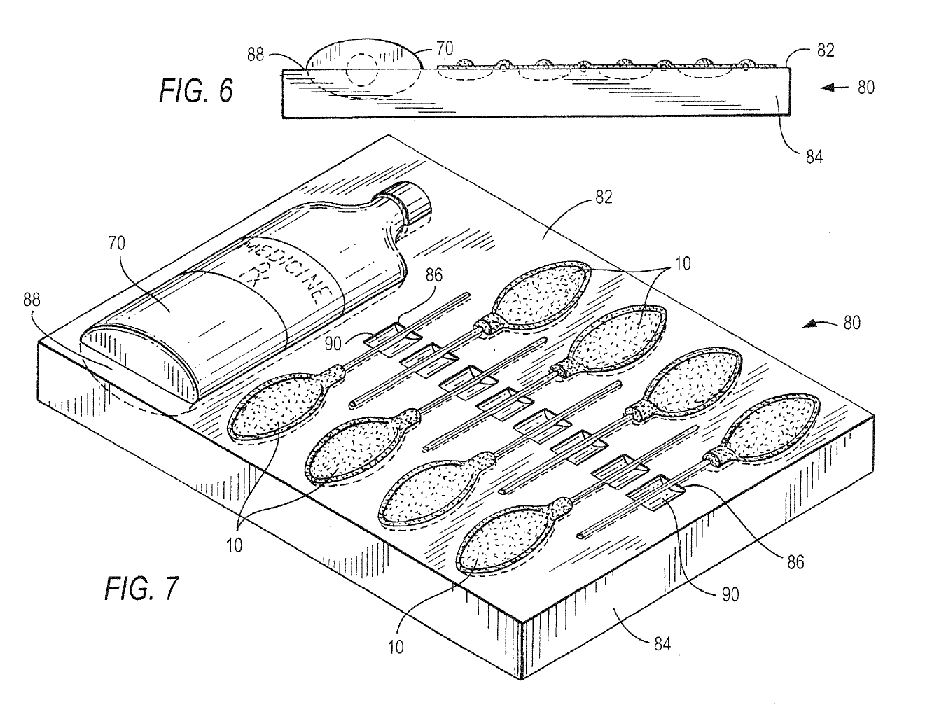

FIG. 6-7 illustrate another embodiment of the lollipops 10 packaged with a bottle of medication 70: a cardboard or plastic carrier 80 having a top 82 and side walls 84 has cutouts or recesses 86 sized and shaped to accept lollipops 10 and a recess 88 sized and shaped to accept a bottle of liquid medicine 70. The recesses and cutouts 86 may have wings 90 for securing the stems 20 and thus holding the lollipops 10 in place on the top 82.

A number of lollipops 10 (wrapped individually or as a group) may be attached to the exterior of the bottle of medication 70, as illustrated in FIG. 9, secured to the bottle by a rubber band 100 or a similar restraint.

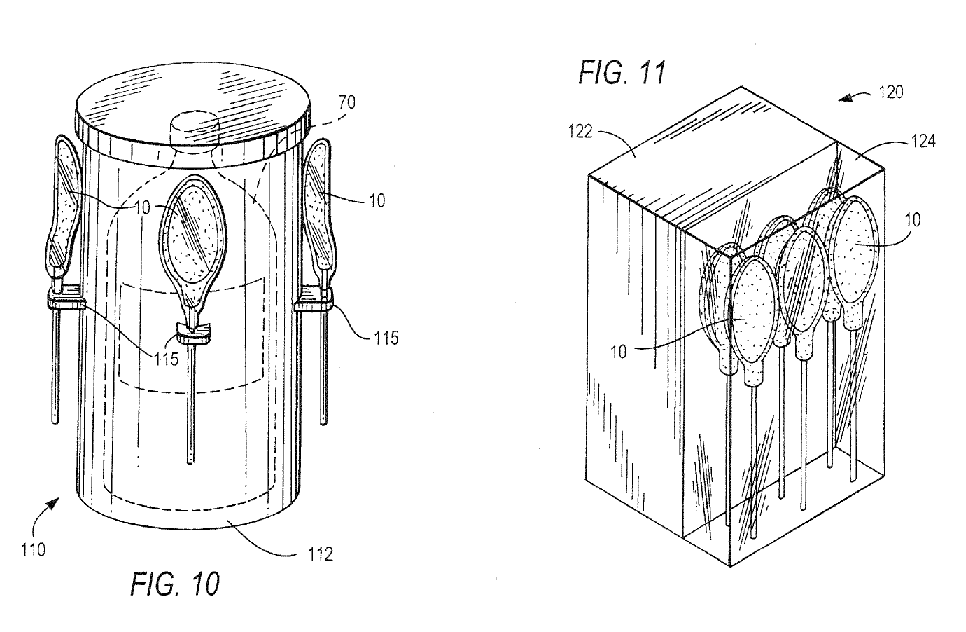

FIG. 10 illustrates another way of distributing of the edible spoons: individually wrapped lollipops 10 are attached to the exterior of a container 110 where the container 110 also holds a bottle of liquid medication 70. The lollipops 10 are preferably attached to the container 110 by protrusions 115, extending outward from the exterior of the container wall 112.

FIG. 11 illustrates yet another way of packaging that can be used for the edible spoons. A container 120 has a first compartment 122 and a second compartment 124, the second compartment 124 preferably made out of or covered with clear, see-through plastic. A bottle of medication 70 is stored in the first compartment 122, and the lollipops 10 are stored in the second compartment 124, visible to the purchasing public.

All of the described attachment methods where the lollipops 10 are attached to the exterior of the bottle 70 or the container/carrier holding the bottle, or where the lollipops 10 are visible through clear plastic of the container increase the preventability of the present invention and appeal of the edible spoons to children and adults purchasing liquid medications.

Although the invention has been described in terms of particular embodiments, the embodiments are merely illustrative of an application of the principles of the invention. Numerous modifications may be made and other arrangements may be devised without departing from the spirit and scope of the invention.

What is claimed is:

1. An edible spoon for administering liquid medications, comprising:
an elongated member having a first end and a second end; and
an edible spoon member having a lollipop taste and a proximal end and a distal end, said second end of said elongated member being encased in said proximal end of said edible spoon member, wherein said edible spoon member is attached to said elongated member to simulate a lollipop, said edible spoon member having a recess for receiving liquid medication therein.

2. The edible spoon of claim 1 wherein said elongated member includes a retaining bulb on said second end, said bulb being encased in said proximal end of said edible spoon member.

3. The edible spoon of claim 1 wherein said elongated member is substantially flat.

4. The edible spoon of claim 3 wherein said elongated member includes a retaining bulb on said second end, said bulb being encased in said proximal end of said edible spoon member.

5. The edible spoon of claim 1 wherein said edible spoon member is made of a confectionary material.

6. A system for administering liquid medications, comprising:
a container with liquid medication; and
at least one edible spoon for administering liquid medication affixed to the outside of said container said at least one edible spoon comprising:
an elongated member having a first end and a second end; and
an edible spoon member having a lollipop taste and a proximal end and a distal end, said second end of said elongated member being encased in said proximal end of said edible spoon member, wherein said edible spoon member is attached to said elongated member to simulate a lollipop, said edible spoon member having a recess for receiving liquid medication therein.

7. The system of claim 6 wherein said elongated member includes a retaining bulb on said second end, said bulb being encased in said proximal end of said edible spoon member.

8. The system of claim 6 wherein said elongated member is substantially flat.

9. The system of claim 8 wherein said elongated member includes a retaining bulb on said second end, said bulb being encased in said proximal end of said edible spoon member.

10. The system of claim 6 wherein said edible spoon member is made of a confectionary material.

11. A system for administering liquid medications, comprising:
a container with liquid medication;
at least one edible spoon for administering liquid medication, said at least one edible spoon comprising:
an elongated member having a first end and a second end; and
an edible spoon member having a lollipop taste and a proximal end and a distal end, said second end of said elongated member being encased in said proximal end of said edible spoon member, wherein said edible spoon member is attached to said elongated member to simulate a lollipop, said edible spoon member having a recess for receiving liquid medication therein; and
a package for holding said container and said at least one edible spoon.

12. The system of claim 11 wherein said elongated member includes a retaining bulb on said second end, said bulb being encased in said proximal end of said edible spoon member.

13. The system of claim 11 wherein said elongated member is substantially flat.

14. The system of claim 13 wherein said elongated member includes a retaining bulb on said second end, said bulb being encased in said proximal end of said edible spoon member.

15. The system of claim 11 wherein said edible spoon member is made of a confectionary material.

16. The system of claim 11 wherein said package holds said container and said at least one edible spoon therein.

17. The system of claim 16 wherein said package includes a first compartment for holding said container and a second compartment for holding said at least one edible spoon.

18. The system of claim 11 wherein said least one edible spoon is affixed to the outside of said package.

19. The system of claim 11 wherein said container and said at least one edible spoon are held in cooperating holders inside said package.
